(19) United States
(12) Patent Application Publication
(10) Pub. No.: US 2009/0179852 A1
(43) Pub. Date: Jul. 16, 2009

(54) VIRTUAL MOVING SCREEN FOR RENDERING THREE DIMENSIONAL IMAGE

(76) Inventors: Hakki H. Refai, Bixby, OK (US); James J. Sluss, JR., Broken Arrow, OK (US)

Correspondence Address: DUNLAP CODDING, P.C., PO BOX 16370, OKLAHOMA CITY, OK, 73113, US

(21) Appl. No.: 12/353,964

(22) Filed: Jan. 14, 2009

Related U.S. Application Data
(60) Provisional application No. 61/020,935, filed on Jan. 14, 2008.

(51) Int. Cl. G09G 3/34

(52) U.S. Cl. 345/107

(57) ABSTRACT

A method of producing multiple three-dimensional images to create an optical illusion of movement, comprising the steps of: (a) energizing particles suspended within a volumetric display sequentially along the length and width of the volumetric display through projection of electromagnetic energy of one or more wavelengths, the energized particles forming a two-dimensional image; b. intersecting the energized particles through projection of electromagnetic energy of one or more wavelengths along the depth of the volumetric display; c. synchronizing the projection of electromagnetic energy along the length and width of the volumetric display with the projection of electromagnetic energy along the depth of the volumetric display for a pre-determined length of time forming an illuminated three-dimensional image; and d. repeating steps a, b and c for each of the plurality of three-dimensional images using a predetermined scanning sequence to create the optical illusion of movement.

### CROSS-REFERENCE TO RELATED APPLICATIONS

The present patent application claims priority to the provisional patent application identified by U.S. Ser. No. 61/020,935, the entire content of which is hereby incorporated herein by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO A “SEQUENCE LISTING”, A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

Not applicable.

### BACKGROUND OF THE INVENTION

Technological advances of the last decade have made scientists and engineers increasingly aware of three dimensional imaging as both viable and realistic. There is now widely acknowledged incentive, both commercially and industrially, for developing a color 3-D display system that can be viewed from unencumbered perspectives. Recent developments using micro-materials and nanostructure materials offer possibilities for creating novel optically-writable displays that are efficient and robust.

The three-dimensional displays currently available in the market, including static-volume displays and swept-volume displays, purport to construct three-dimensional images which are uniform in a 3-D image space and viewable from practically any orientation. In practice, these technologies have not fully achieved their objectives and possess several drawbacks including low resolution and translucent image representations.

Accordingly, a three dimensional imaging system and method of using the imaging system to provide better-quality images, as compared with the currently available technologies, will provide a commercially and industrially marketable product.

### BRIEF SUMMARY OF THE INVENTION

The present invention is related to a light surface display for providing a three-dimensional image. In general, the light surface display includes a plurality of particles suspended within a volumetric display, that when energized by electromagnetic energy of two or more wavelengths, illuminate to form a three dimensional image.

In one embodiment, the light surface display includes a first projection system projecting wavelengths forming sequential slices of a two-dimensional image along the length and width of the volumetric display, and a second projection system projecting wavelengths forming translational slices having any predetermined screen shape across the depth of the volumetric display. A control system synchronizes the projections of the first projection system and the second projection system so that the wavelengths forming the two-dimensional image and the translational slices energize the particles in the volumetric display for a pre-determined length of time. The energized particles illuminate to form a three-dimensional image. The control system can also be adapted to illuminate multiple three-dimensional images using any predetermined scanning sequence, such as back and forth scanning or interlaced scanning to create an optical illusion of movement. Any type of optical illusion of movement can be provided such as a full rotating screen, half rotating screen, two Archimedes spirals rotating around a common center, single spiral rotating screen or the like. The light surface display may produce a monochromatic or polychromatic image depending on the particular wavelength of electromagnetic energy and/or the types of particles utilized.

The particles within the volumetric display preferably include selectively-activated light sources activated by the incidence of one or more directional light sources such as lasers, coherent LED's, or the like. For example, particles may include micro and/or nano particles such as quantum dots, upconversion materials, or similar particles as long as the particles are selectively-activated by the incidence of a directional light source.

In one version, the first projection system projects wavelengths for a pre-determined amount of time prior to the second projection system in order to vary the color and/or intensity of each particle. The power of the first projection system may also be modulated to vary the intensity of the electromagnetic energy in order to vary the relative brightness of each particle. Additionally, the projection systems may include digital light processing projectors having digital micro-mirror devices containing an array of micromechanical mirrors. The micromechanical mirrors may be used in a plurality of array groups for dithering the translational slice to alter the relative brightness or color depth of each particle that represents a voxel.

The control system may optionally interface with an external source in order to provide images to the light surface display. The external source may include a computer, a processor, a game console, the Internet or the like.

In another embodiment, the light surface display further comprises a housing containing the volumetric display and/or projection systems. In addition to providing support for the volumetric display and/or projection systems, the housing provides an element of safety in securing the particles against outside contact with the user or spectator if needed. Additionally, the light surface display can include a filter, such as an electromagnetic radiation filter, preventing exposure of non-visible radiation to the user or spectator.

In another embodiment, the light surface display further comprises a medium that is substantially transparent and dispersed within the volumetric display. Preferably, the suspension of the particles is substantially uniform throughout the medium. The medium may be formed of high temperature transparent polymers, transparent ceramics, transparent aerogel materials, xenogel materials, or any other material that is substantially transparent and provides suspension of the particles within the volumetric display. The medium may be formed of inorganic substances, organic substances or combinations thereof.

In another aspect, the present invention is directed toward a method of using a light surface display to produce a three-dimensional image. The light surface display includes a plurality of particles suspended within a volumetric display. The particles are energized sequentially along the length and width of the volumetric display forming a two-dimensional image. The particles are further energized by intersection of electromagnetic energy along the depth of the volumetric display. The energizing of the particles is synchronized so as to form an illuminated three-dimensional image.

### BRIEF DESCRIPTION OF THE SEVERAL VIEW OF THE DRAWINGS

So that the above recited features and advantages of the present invention can be understood in detail, a more particular description of the invention, briefly summarized above, may be had by reference to the embodiments thereof that are illustrated in the appended drawings. It is to be noted however that the appended drawings illustrate only typical embodiments of the invention and are therefore not to be considered limiting of its scope, for the invention may admit to other equally effective embodiments.

FIG. 1 is a schematic block diagram of a light surface display providing a three-dimensional image within a volumetric display in accordance with the present invention.

FIG. 2 illustrates exemplary wavelengths of visible light generated by energizing a particle with two wavelengths.

FIG. 3 is a schematic diagram of one example of a projection system in accordance with the embodiment of FIG. 1.

FIG. 4A is a perspective view of an embodiment of a light surface display providing a three-dimensional image within a volumetric display in accordance with the present invention. FIG. 4B is a schematic view of the light surface display in FIG. 4A.

FIG. 5A is a schematic view of another embodiment of a light surface display providing a three-dimensional image in accordance with the present invention. FIG. 5B and FIG. 5C are exemplary versions of the light surface display of FIG. 5A.

FIG. 6 is a schematic view of another embodiment of a light surface display providing a three-dimensional image in accordance with the present invention.

FIG. 7 is a perspective view of one version of a light surface display housing in accordance with the present invention.

FIG. 8 is a light surface display providing a three-dimensional image having a full rotating screen.

FIG. 9 is a light surface display providing a three-dimensional image having a half rotating screen.

FIG. 10 is a schematic view of another embodiment of a light surface display providing a three-dimensional image in accordance with the present invention.

FIG. 11 illustrates exemplary translational motion of a moving slice sweeping across a volumetric image space.

FIG. 12 illustrates the effect of the translation motion of FIG. 11 on a slice located midway in the volumetric image space range of movement.

FIG. 13 illustrates another exemplary translational motion of a moving slice having an interlacing feature.

FIG. 14 illustrates a marking system constructed in accordance with the present invention utilizing concepts of the invention discussed above but forms a permanent image within a substrate rather than an illuminated three dimensional image formed of energized particles as discussed above.

FIG. 15 is a schematic, diagrammatic illustration of an optional magnifier device utilized with the light surface display depicted in FIG. 1.

### DETAILED DESCRIPTION OF THE EMBODIMENTS

Present embodiments of the invention are shown in the above-identified figures and described in detail below. In describing the embodiments, like or identical reference numerals are used to identify common or similar elements. The Figures are not necessarily to scale and certain features in certain views of the Figures may be shown exaggerated in scale or in schematic in the interest of clarity and conciseness.

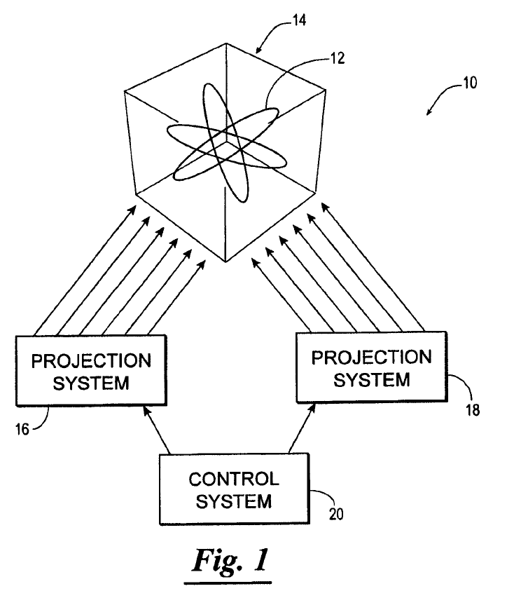

Referring now to the drawings, and in particular to FIG. 1, shown therein and designated by reference numeral 10 is a light surface display, constructed in accordance with the present invention, for providing a three-dimensional image 12 within a volumetric display 14. In general, the light surface display 10 includes a plurality of particles, suspended within the volumetric display 14, that when energized by electromagnetic energy, illuminate forming a three-dimensional image 12.

The light surface display 10 is provided with a first projection system 16 projecting electromagnetic energy of one or more wavelengths forming sequential slices of a two-dimensional image along the length and width of the volumetric display 14, and a second projection system 18 projecting electromagnetic energy of one or more wavelengths forming translational slices across the depth of the volumetric display 14. Although FIG. 1 demonstrates the use of two projection systems 16 and 18, it is contemplated that additional projection systems may be used to provide assistance in projecting electromagnetic energy of one or more wavelengths along the length, width, and/or depth of the volumetric display 14. Additional projection systems may provide better resolution, color selectivity, and/or brightness.

A control system 20 synchronizes the projections of the first projection system 16 and the second projection system 18 so that electromagnetic energy of the wavelengths forming the two-dimensional image and the translational slices intersect on individual particles to energize the particles for a pre-determined length of time. The energized particles illuminate to form the three-dimensional image 12. Depending on the amount of projection systems and/or type of particles in use, the light surface display 10 is able to produce monochromatic images and/or polychromatic images.

The particles within the volumetric display 10 preferably include selectively-activated light sources capable of activation by the incidence of one or more directional light sources such as lasers, coherent LED's, or the like. Activation of the particles adjusts the physical properties and/or characteristics displayed by the particles. In the preferred embodiment, activation provides visible light generation of varying wavelengths.

Particles may include micro and/or nano selectively-activated light sources or combinations of micro and/or nano selectively-activated light sources such as quantum dots, upconversion materials, or the like. For example, by varying the size and shape of quantum dots, and the depth of potential, the energy level of the quantum dots can be controlled. The discretional nature of the quantum dot bands means that the energy separation between the valence and conduction bands can be altered with the addition or subtraction of at least one atom. Predetermination of the quantum dot size fixes the emitted photon wavelength at about a specific color allowing quantum dots to be suitable selectively-activated particles for use in the light surface display 10.

Upconversion materials provide another example of suitable selectively-activated particles. Upconversion materials, in essence, convert lower energy beams into higher energy visible beams and can function as light emitting phosphors. Brightness obtained through the use of an upconversion material may be varied by altering the intensity of the electromagnetic energy impinging the surface of the upconversion material.

Upconversion materials may include a host material doped with a sensitizer and then further doped with any suitable ions, such as rare-earth ions. For example, the particles may include fluoride crystal as a host material, doped with ytterbium (Yb³⁺) as a sensitizer and further doped with rare-earth ions. The rare-earth ions may include erbium (Er³⁺), holmium (Ho³⁺), and thulium (Tm³⁺), or other similar particles and/or lanthanides that are excited by and emit fluorescence at different wavelengths. Doping a fluoride crystal with Er³⁺, Ho³⁺, and Tm³⁺ enables the fluoride crystal to emit red, green, and blue upconversion emitters, respectively. Other host materials, such as oxysulfide, and other rare-earth doping ions can also be used to construct the particles. It is contemplated that other selectively-activated particles may be used with the light surface display 10 as long as the particles are capable of activation by the incidence of one or more directional light sources.

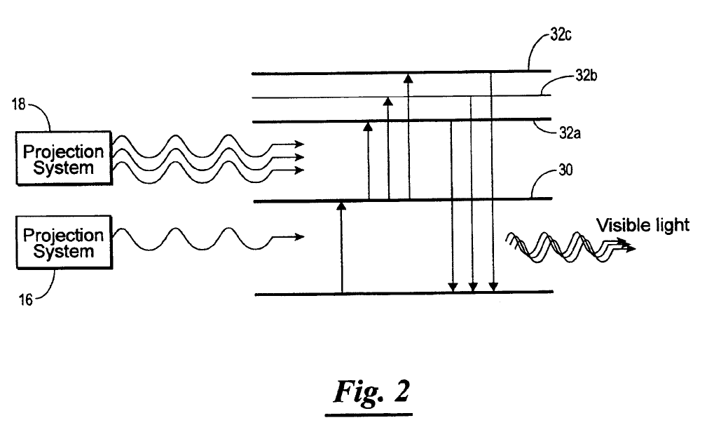

In general, exciting a particle with electromagnetic energy of different wavelengths produces visible light from the particle of a specified color depending on the utilized excitation wavelengths and the doping of the particle. For example, as shown in FIG. 2, if the first projection system 16 uses the common infrared wavelength 30 to all particles, then color selectivity is chosen according to a second wavelength 30 to 32a, 30 to 32b, or 30 to 32c, provided by the second projection system 18. The first projection system 16 and the second projection system 18 can be provided with multiple separate projectors for enhancing the selectivity of the color or power provided to the particles. As one example, the first projection system 16 can be provided with six projectors with each projector providing a different wavelength. Each visible color can be emitted from the particle through the use of at least two different wavelengths without the need for a common wavelength. For example, six separate projection systems may provide six separate wavelengths (W₁, W₂, W₃, W₄, W₅, W₆), the combinations of which (W₁×W₂, W₃×W₄, W₅×W₆) provide for RGB color selectivity respectively. Alternatively, each projection system may provide for multiple wavelengths as discussed in more detail below.

Particles are suspended within the volumetric display 14. Substantial uniformity in the suspension of the particles through the volumetric display 14 is preferred. Particles may be suspended through magnetic suspension, convection currents, and/or dispersed within a medium.

Substantial uniformity in the dispersion of the particles within the medium is preferred. A suitable medium should include characteristics such as high transparency, durability, and/or low phonon energy. A phonon is a discrete amount of energy that a medium can absorb. If the medium absorbs the incoming energy, this energy will not be available for light emission, and therefore reduce the brightness of the light surface display 10.

The medium may be formed of high temperature transparent polymers, transparent aerogel materials, xerogel materials, or any other material permitting substantial uniformity of particle dispersion. The medium may be composed of an inorganic substance, an organic substance, or combinations thereof. For example, the medium can be an aerogel matrix in which the particles are synthesized with the aerogel matrix to create transparent optically-active monoliths. Aerogel matrices offer unique properties because they can be up to 99% air thus eliminating up to 99% of material interference with emitted light. This factor diminishes the light absorption within the aerogel matrix and allows for brighter light to be emitted. The aerogel matrix surface also does not touch the particles completely thus reducing surface contact and quenching effects on the emitted visible light of the particles.

The particles are dispersed much like a cloud within the aerogel matrix allowing for high illumination. An example of such an aerogel matrix includes, but is not limited to, silicon oxide aerogel. Silicon oxide aerogel matrices can be formed with surface areas of up to about 2000 m²/g and densities of about 0.002 g/cm³ providing a high magnitude of surface area that is light accessible. However, it should be noted, that other types of mediums, including other aerogel matrices or polymers may be used, provided the medium allows for dispersal of the particles in at least a portion of the medium used to form the volumetric display 14.

Referring now to FIGS. 1 & 3, using image projection technology such as digital light processing (DLP), grating light valve (GLV), and/or the like, the projection systems 16 and 18 provide electromagnetic energy of different wavelengths to energize the particles in the volumetric display 14.

In one embodiment, at least one of the projection systems 16 and/or 18 of the light surface display 10 uses DLP technology. Examples of DLPs include, but are not limited to, the Discovery 1100 model which uses 0.7 XGA DDR DMD which operates at 60 MHz DDR clock and provide 7.7 GbS data transfer rate and the Discovery 3000 which uses the 0.7 XGA LVDS DMD which operates at 200 MHz DDR clock and provides a 12.8 GbS data transfer rate.

In general, DLP includes a digital micromirror device (DMD) containing an array of micromechanical mirrors producing resolutions of super video graphics array (SVGA) 800×600 pixels; extended graphics array (XGA), 1024×768 pixels; 720p 1280×72; and 1080p, 1920×1080 pixels, pico-size DMD, and/or other like matrices.

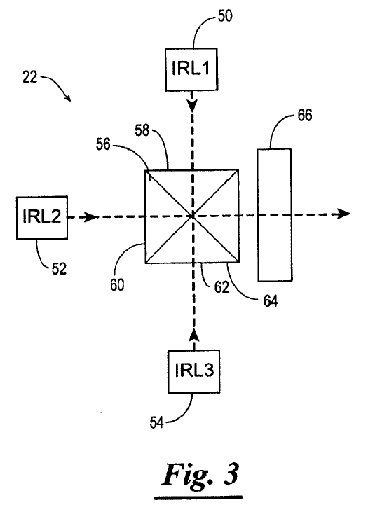

FIG. 3 illustrates the projection system 18 using three-chip DLP technology with three different light sources, 50, 52, and 54. The light sources 50, 52, and 54 may include lasers, coherent LEDs, or the like. Other light sources may be used as long as the spectral line width of the light source is narrow and the output beam is directional. Each of the light sources 50, 52, and 54 provides a separate wavelength passing through a special four-sided prism 56. The prism 56 guides the wavelengths from each of the light sources 50, 52, and 54 to the corresponding DMD 58, 60, and 62 respectively. The wavelengths from each of the light sources, 50, 52, and 54 is reflected from the DMD surfaces, 58, 60, and 62 and combined. The combination is passed through an open fourth side 64 of the prism 56 to the projection lens 66. The projection lens 66 directs the combination towards the particles in the volumetric display 14.

Alternatively, the projection systems 16 and 18 may include grating light valve technology (GLV). GLV is a diffractive micro-opto-electro-mechanical system (MOEMS) spatial light modulator capable of very high-speed modulation of light combined with fine gray-scale attenuation. GLV is capable of projecting a one-dimensional array through a second dimension, creating a full high-definition image.

In another embodiment, in accordance with the present invention, the light surface display 10 utilizes both DLP and GLV technology in rendering a three-dimensional image 12. For example, in FIG. 1, the first projector system 16 may use DLP to create a series of 2D image slices, while the second projector system 18 uses GLV to create a series of transitional slices.

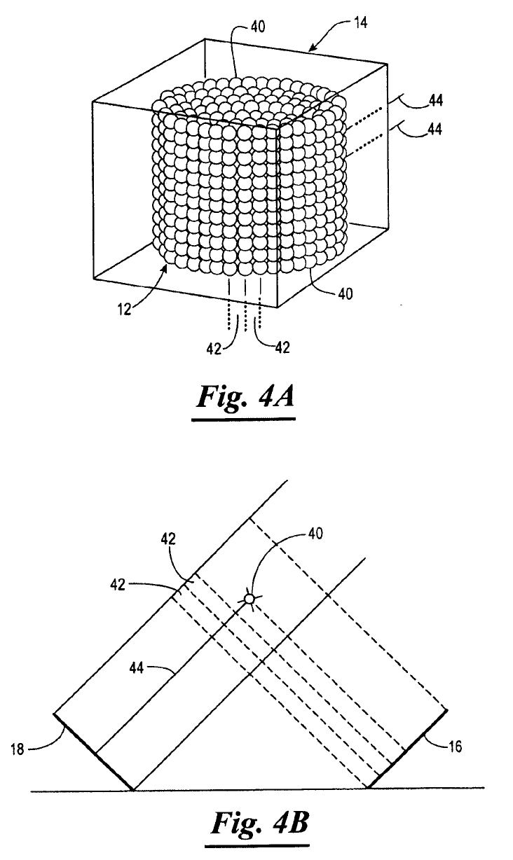

As illustrated in FIG. 4, at least two projection systems 16 and 18 are utilized to construct the three-dimensional image 12 within the volumetric display 14. The intersection of the projected electromagnetic energy of the first projection system 16 and the second projection system 18 activates the particles creating voxels 40 forming the three-dimensional image 12.

The first projection system 16 may include a single DLP or a single GLV, a single LCD, a single CRT, or any type of projection system. The projection system 16 is used to project electromagnetic energy of one or more wavelengths to form sequential two-dimensional slices 42 projecting across the length and width of the volumetric display 14. The projected electromagnetic energy may include non-visible wavelengths, such as an infrared wavelength or an ultra-violet wavelength, or a combination of two or more infrared and/or ultra-violet wavelengths depending on the projection system and/or the particles utilized.

The second projection system 18 contains a single DLP or a single GLV, a single LCD, a single CRT, or any type of projection system. The second projection system 18 projects electromagnetic energy of one or more wavelengths to form planar translational slices 44 translating across the depth of the volumetric display 14. The projected electromagnetic energy can include non-visible wavelengths, such as an infrared wavelength or ultra violet wavelength, or a combination of two or more infrared and/or ultraviolet wavelengths depending on the projection system and/or the particles utilized.

In one embodiment, the projected electromagnetic energy from the first projection system 16 is the common infrared wavelength IRL0 forming the sequential two-dimensional slices 42, and the projected electromagnetic energy from the second projection system 18 consists of three different infrared wavelengths IRL1, IRL2, and IRL3 projected in sequence for each planar translational slice 44. To produce the planar translational slice 44, all of the micromirrors of the second projection system 18 are set to the off-state except the first column and/or row, depending on the physical positioning of the projection system 18 and/or volumetric display 14. The projection of the planar translational slice 44 is synchronized to the projection of the two-dimensional slices 42 from the first projection system 16. The approximately 90 degree intersection of the planar translational slice 44 with the two-dimensional slice 42 for a specified length of time energizes the particles at the intersection and creates an illuminated two-dimensional cross section at a specified location within the volumetric display 14. Changing the wavelengths of the planar translational slices 44 projected by the second projection system 18 provides the means to generate red, green, and/or blue, along with a multitude of colors based on the combinations of red, green, and/or blue.

To further create the three-dimensional image, all of the micromirrors in the second projection system 18 are again switched to the off-state except for a second column and/or row depending on the orientation of the second projection system 18 and/or volumetric display 14. A second intersection occurs between a second two-dimensional slice 42 and a second planar translational slice 44 illuminating a second two-dimensional cross section at a specific location in the volumetric display 14. It is possible for the second projection system 18 to project two or more columns and/or rows simultaneously for each planar translational slice 44.

Synchronizing the operations of both projection systems 16 and 18 allows the series of illuminated cross sections of the two-dimensional slice 42 and the planar translational slice 44 to appear at a depth within the volumetric display 14. Repeating the projections from the first projection system 16 and the second projection system 18 throughout the entire volumetric display 14 creates the three-dimensional image 12.

The resolution, color, and/or brightness of the image may be manipulated by altering the projection of electromagnetic energy from the projection system 16 and 18. For example, allowing for a pre-determined amount of time between projection by the first projection system 16 and projection by the second projection system 18 can vary the color and/or intensity of each particle. Activation by the first projection system 16 allows the particles to energize. A time-delay after projection by the first projection system 16 allows the energy to dissipate before activation by the second projection system 18. The dissipation of energy allows for variations in particle color and/or intensity. Additionally, altering the amplitude of wavelength of electromagnetic energy projected by either the first projection system 16 and/or the second projection system 18 can vary the intensity and vary the relative brightness of each particle.

As previously discussed, the projection systems 16 and 18 may include DLPs having digital micro-mirror devices containing an array of micromechanical mirrors. The micromechanical mirrors may be used in a plurality of array groups for dithering the translational slice to alter the relative brightness of each particle that comprises a voxel. In this technique, each particle receives electromagnetic energy that has been reflected from a plurality of micromechanical mirrors; the brightness is then controlled by selecting the number of micromechanical mirrors in this plurality. For example, using a 2×2 array of DLP micro-mirrors provides a relative color depth per voxel from zero to four depending on how many mirrors in the array group are activated at any given time. Larger micro-mirror array groups can provide corresponding greater color depth. It is noted that this dithering method decreases the overall resolution of the display and that multiplexing the micro-mirrors in time or controlling the laser power and/or laser activation timing to provide color depth are the preferred embodiments.

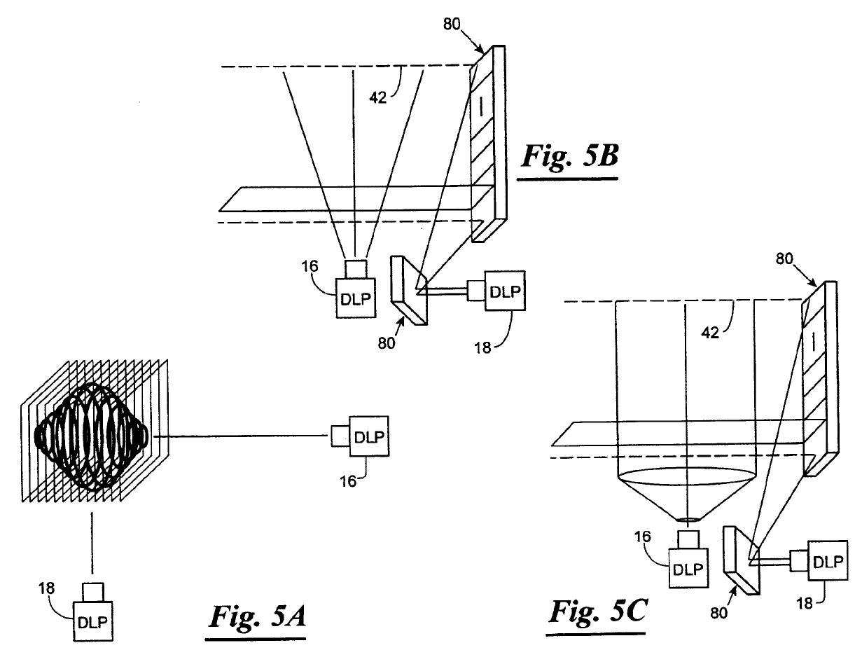

As illustrated in FIGS. 5A, 5B, and 5C, the physical placement of the projection system 16 and 18 and/or directing of the electromagnetic energy provided by the projection systems 16 and 18 can provide for multiple viewing angles of the three-dimensional image 12. For example, as shown in FIGS. 5A and 5B a 270-degree viewing of the three-dimensional image 12 is produced when the first projection system 16, projecting the two-dimensional cross section, occupies one side of the volumetric display 14 and the projected planar transitional slices are projected by the second projection system 18 on the perpendicular side of the volumetric display 14. In another version, as illustrated in FIG. 5C, the first projection system 16 utilizes a beam expander to provide the array of electromagnetic energy in a collimated beam to the volumetric image space (or display) 14.

The planar transitional slices are projected to the volumetric display 14 through the use of a steering system 80. The steering system may include one or more mirrors, including deformable mirrors, that can be mechanically or electrically altered to guide the electromagnetic energy from the projection system 18 to the volumetric display 14.

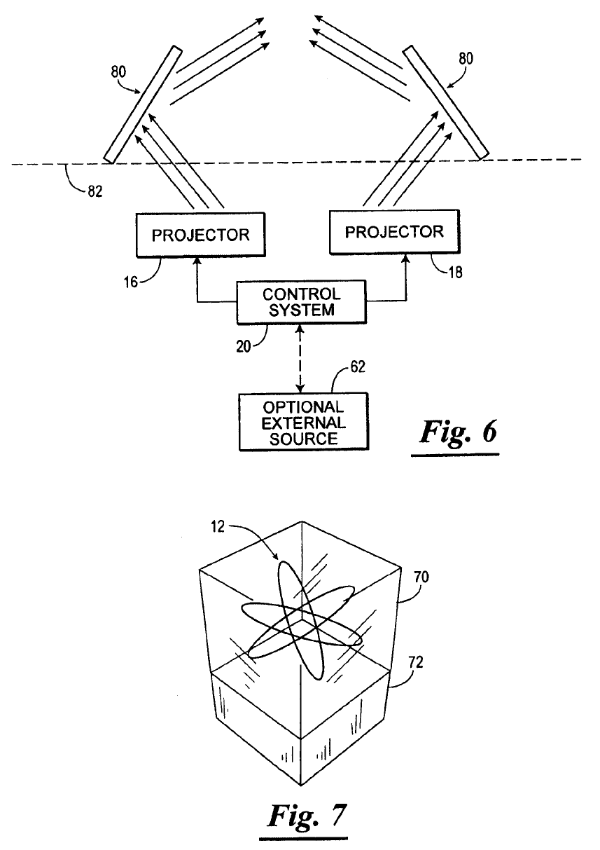

Alternatively, as shown in FIG. 6, the steering system 80 can provide 360 degree viewing by angling the projections from the first projection system 16 and the second projection system 18 so that they are tilted from a base 82. Preferably, electromagnetic energy from the first projection system 16 and the second projection system 18 will ideally intersect the particle at relative angles of approximately 90 degrees although other angles of intersection are contemplated. Having the intersection at an angle of approximately 90 degrees may eliminate any distortional dead zones resulting from voxel elongation, wherein the distortional dead zone is the region in which the size and/or shape of the individual voxels deviates substantially from the ideal. Control of the steering system may be provided by the projection systems 16 and 18, the control system 20, and/or mechanical manipulation by the user.

The control system 20 refreshes the images at a frequency sufficient to ensure that the user and/or spectator perceive the visual data as continually present. In one example, the volumetric display 14 is in the form of a rectangle with sides of lengths l×k comprising n by m pixels. Any combination of these n×m pixels can be activated during each refresh period. For example, if n=1024 rows, and m=768 pixels, the resultant number of pixels is 786,432 pixels generated using the first projection system 16. Flicker considerations give rise to a minimum image refresh frequency. Therefore, if the second projection system 18 provides 333 slices across the depth of the volumetric display 14, the first projection system 16 and the second projection system 18, then the control system 20 refreshing the projection systems 16 and 18 at the same frequency, would provide 8000 images/sec from the first projection system 16 and 8000 images/sec from the second projection system 18. In this example, the generated volumetric display 14 would provide 225 million-voxels for a single color image and 85 million-voxels for a three-color image and 111 slices across the depth. The obtained three-dimensional image 12 is comprised of 24 three-dimensional images 12 per second (refresh rate).

In another example, the first projection system 16 utilizes a DLP projector with three different light sources simultaneously projecting the two-dimensional image and the second projection system 18 slices the two-dimensional images with a single light source such as a common infra-red laser. In this example, when the first projection system emits 1024×768 images, and the second projection system slices 666 columns, synchronization by the control system 20 generates the volumetric display 14 with 500 million-voxels for multi-color images.

In another example, the projection systems 16 and 18 described herein operate at a rate of 16,000 frames/sec. The illuminated cross sections within the volumetric image space (or display) 14 take the form of rectangle comprised of n by m pixels. Any combination of these n×m pixels are activated during each refresh period. If n=1920 rows and m=1080 columns, the resultant number of pixels generated for each 2D cross section is 2.0736 million pixels. If the equivalent volumetric image space (or display) 14 provides an additional spatial dimension (depth) d equal to 666 slices generated then flicker considerations give rise to a minimum image refresh frequency equal to twenty-four-three-dimensional images/sec. The first projection system 16 will project a continuous combination of three mixed wavelengths to provide three color images at 16,000 images/sec.

To provide moving images, the three-dimensional image 12 is projected at least 24 times/sec, leading to a three-dimensional projection speed equal to 666 images/sec. The second projection system 18 switches 666 columns or rows to create 666 slices/sec, over the depth of the volumetric image space (or display) 14. The resultant projection system speed is 15984 frames/sec with a switching speed for the three different wavelengths at 7992 switches/sec. Thus, the volumetric image space (or display) 14, having more than 666 slices for the depth direction and 1,381 million voxels for multi-color image, gives a resulting three-dimensional image 12 comprised of twenty-four three-dimensional images/sec (refresh rate).

The control system 20 can also be programmed to render three dimensional images according to any mechanical concept without depending upon any mechanical motions. The volumetric image space (or display) 14 is preferably static, i.e., non-moving, and utilizing the control system 20 described below, can be attached via the control system 20 with any 3D display interface (3D Graphic Engine) that depends on mechanical motions, such as the 3D Graphic Engines described in Appendix A. The control system 20 can also be adapted to illuminate multiple three-dimensional images using any predetermined scanning sequence, such as back and forth scanning or interlaced scanning to create an optical illusion of movement. Any type of optical illusion of movement can be provided such as a full rotating screen, half rotating screen, two Archimedes spirals rotating around a common center, single spiral rotating screen or the like.

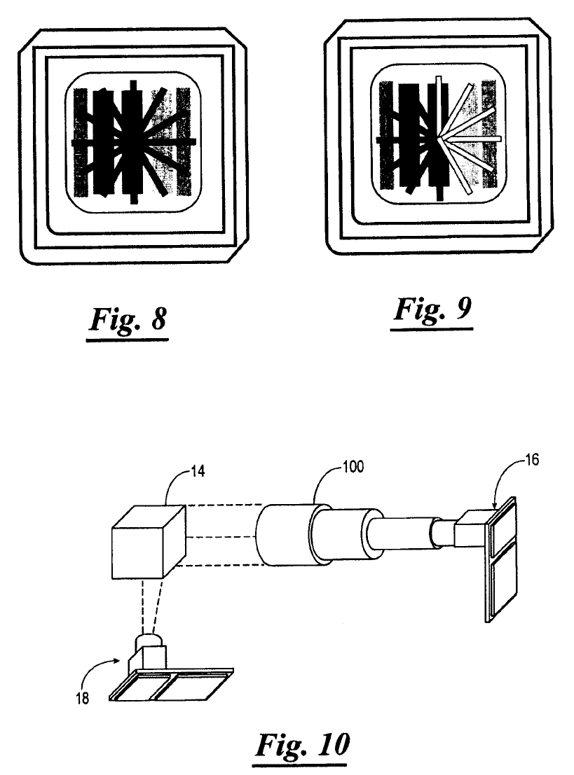

For example, to produce a full rotating screen (slice) (and when the second projection system 18 is a DLP having the array of micromirrors), the control system 20 sets all of the micromirrors of the second projection system 18 to an off-state except the center horizontal row, vertical column, diagonal line, or any line with angle with the X or/and Y axis as shown in FIG. 8, depending on the physical position of the second projection system 18 and/or volumetric image space (or display) 14. The projection of electromagnetic energy in the form of the spinning screen (slice) is synchronized to the projection of the electromagnetic energy in the form of two-dimensional slices from the first projection system 16. The intersection of the electromagnetic energy in the form of the rotating screen with the two-dimensional slice for a specified length of time energizes the particles at the intersection and creates an illuminated two-dimensional cross section at a specified location within the volumetric image space (or display) 14. Changing the wavelengths of the rotating screen (slice) projected by the second projection system 18 provides the means to generate red, green, and/or blue, along with multitude of colors based on the combinations of red, green, and/or blue.

To further create the three-dimensional image, the control system 20 switches all of the micromirrors in the second projection system 18 to the off-state except for a rotated line (an angle shifted line compared with the previous line) clockwise, or counterclockwise depending on the orientation of the second projection system 20 and/or the volumetric image space (or display) 14. A second intersection occurs between electromagnetic energy in the form of a second two-dimensional slice and a second planar rotating slice illuminating a second two-dimensional cross section at a specific location in the volumetric image space (or display) 14. It is possible for the second projection system 18 to project electromagnetic energy in the form of two or more pixel width lines simultaneously for each planar rotating slice. By synchronizing the operations of both the first and second projection systems 16 and 18, the control system 20 causes the series of illuminated cross sections of the two-dimensional slice and the planar rotating slice to appear at a depth within the volumetric image space (or display) 14. Repeating the projections from the first projection system 16 and the second projection system 18 throughout the entire volumetric image space (or display) 14 creates the three-dimensional image.

As another example, to produce a half rotating screen (slice), the control system 20 sets all of the micromirrors of the second projection system 18 to an off-state with the exception of the center half horizontal row, half vertical column, half diagonal line, or any half line with angle with the X or/and Y axis as shown in FIG. 9, depending on the physical position of the second projection system 18 and/or the volumetric image space (or display) 14. The control system 20 synchronizes the projection of energy in the form of the spinning half screen (slice) to the projection of the energy in the form of two-dimensional slices from the first projection system 16. The intersection of the energy in the form of the half rotating screen with the energy in the form of the two-dimensional slice for a specified length of time energizes the particles at the intersection and creates an illuminated two-dimensional cross section at a specified location within the volumetric image space (or display) 14. As another example, the control system 20 can be programmed to also select the wavelength of the energy projected into the volumetric image space by the first and/or the second projections systems 16 and 18. By changing the wavelengths of energy in the form of the rotating screen (slice) projected by the second projection system 18 provides the means to generate red, green, and/or blue, along with a multitude of colors based on the combinations of red, green, and/or blue.

To further create the three-dimensional image, the control system 20 switches all of the micromirrors in the second projection system 18 to the off-state except for micromirrors collectively forming a shape of a rotated half line (an angle shifted line compared with the previous line) clockwise, or counterclockwise depending on the orientation of the second projection system 18 and/or volumetric image space (or display) 14 to cause a second intersection between the energy in the form of a second two-dimensional slice and energy in the form of a second planar half rotating slice illuminating particles in the shape of a second two-dimensional cross section at a specific location in the volumetric image space (or display) 14. It is possible for the second projection system 18 to project energy in the form of two or more pixel width lines simultaneously for each planar rotating slice. By synchronizing the operations of both projection systems 16 and 18, the control system 20 allows the series of illuminated half cross sections of the two-dimensional slice and the planar half rotating slice to appear at a depth within the volumetric image space (or display) 14. Repeating the projections from the first projection system 16 and the second projection system 18 throughout the entire volumetric image space (or display) 14 creates the three-dimensional image.

Similarly, the control system 20 can be programmed as discussed above to create the illusion within the volumetric image space (or display) 14 of virtually any possible moving shape using the energy projected from the second projection system 18 to be intersected with the energy in the form of projected sequential 2D slices from the first projection system 16. For example, these shapes can be in the form of two Archimedes spirals rotating around a common center, single spiral rotating screen, etc.

Referring now to FIG. 10, to construct a more precise 3D image, the second projection system 18 is provided with a lens 100 in between the first projection system 16 and the volumetric image space (or display) 14, such as a telecentric lens, to collimate the energy forming the shape of the generated slices. The lens 100 can also be installed in between the first projection system 16 and the volumetric image space (or display) 14, the second projection system 18 and the volumetric image space (or display) 14, or both. FIG. 5 shows the utilization of a telecentric lens 100 with only the first projection system 16.

Scanning Process: the control system 20 can be programmed or adapted to control the first and second projection systems 16 and 18 as described hereinafter. The second projection system 18 provides the translational motion for the translational slice across the depth of the volumetric image space (or display) 14. This translational motion can take the following movements:

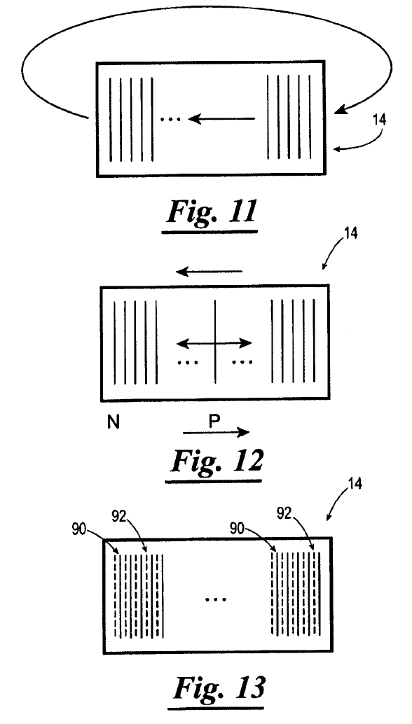

1. The translational motion of the moving slice starts again each time the slice reaches the last location through the image space as shown in FIG. 11.

2. The translational motion of the moving slice sweeps forth and back. This shape of translational movement produce flickers for voxels located at the sides of the volumetric image space (or display) 14. FIG. 12 illustrates this disadvantage. Consider a slice P that is located midway in the volumetric image space (or display) 14 range of movement. If the slice completes a full cycle of movement in a time T (i.e. sweeps back and forth during interval T), then voxels within the slice P will be refreshed at regular intervals of T/2. While, consider slice N located at the extreme of the slice's motion. The refresh of voxels in this slice will occur at intervals of time T. therefore if T=10 ms, voxels located in slice P will be refreshed every 10 ms; while, voxels in slice N will only be refreshed every 20 ms. Hence, voxels lying at the greater distance at the volumetric image space (or display) 14 would appear to flicker if the refresh rate is not enough.

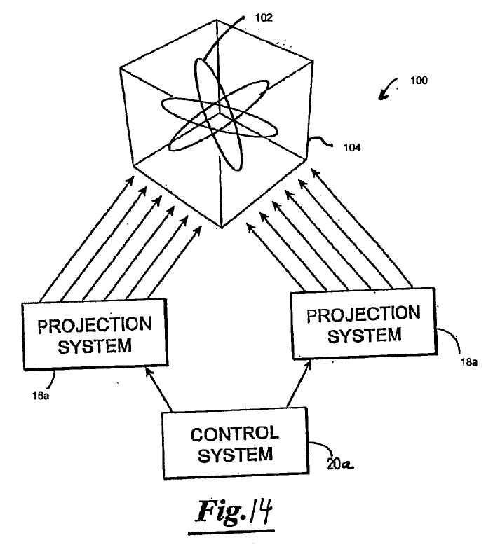

3. The translational motion of the moving slice can be accomplished utilizing either of the previously discussed methods or any other method with an interlacing feature. For example, if the system is utilizing the first method, the system scans odd slices 90 one after other then begins scanning even slices 92, and so on as shown in FIG. 13.

4. An anti-aliasing feature can be added to the scanning method (anti-aliasing provides blurring to the edges of the slices to provide continuously vision between slices).

As illustrated in FIG. 6, the control system 20 may optionally communicate with an external source 62, such as a computer, processor, or the Internet, to provide external control, external programming, permitting measurement and reporting of information regarding the light surface display 10, and/or downloading of images to the control system 20. The external source 62 can be either proximally located to the light surface display 10 or located at a distance so long as there is communication between the control system 20 and the external source 62. Communication between the control system 20 and the external source 62 can be wired or wireless.

As illustrated in FIG. 7, the light surface display 10 may optionally include a housing 70 containing the three-dimensional image 12. In addition to providing support for the particles, the housing 70 provides an element of safety in securing the particles against outside contact with the user or spectator. The housing 70 is constructed of a transparent material forming a transparent area so that a user or spectator located outside the housing 70 can view the image within the housing 70. It should be understood that the amount and/or shape of the transparent material forming the housing 70 can be varied depending upon a number of factors, such as the desired optical effect, or the end use of the light surface display 10. The housing 70 may additionally enclose the projection systems 16 and 18 and/or control system 20. The housing 70 is provided with an opaque area 72 so as to hide various parts of the light surface display 10 from the view of a user or spectator outside of the housing 70. For example, the projection systems 16 and 18 and/or control system 20 can be located adjacent to the opaque area 72 so as to hide the projection systems 16 and 18 and/or control system 20 from the user or spectator.

Additionally, the light surface display 10 can include a filter, such as an electromagnetic radiation filter, preventing exposure of non-visible radiation to the user or spectator. The filter may be integral to the housing 70 or separate from the housing 70.

As discussed above, the light surface display 10 is used to produce three-dimensional images 12. In using the light surface display 10, a volumetric space 14 is provided, wherein a plurality of particles are suspended within the volumetric space 14 via the medium, magnetic suspension or the like. Substantially-uniform dispersion of the particles within the volumetric space 14 is preferred. The particles are energized sequentially along the length and width of the volumetric display 14 through projection of electromagnetic energy of one or more wavelengths. The electromagnetic energy may be provided by one or more projection systems 16 and/or 18. The energized particles form a two-dimensional image along the length and width of the volumetric space 14. The particles are intersected with a projection of electromagnetic energy of one or more wavelengths along the depth of the volumetric display 14. The projection of electromagnetic energy along the length and width of the volumetric display 14 and the projection of electromagnetic energy along the depth of the volumetric display 14 are synchronized for a pre-determined length of time. Synchronization of the projections forms the illuminated three-dimensional image 12.

The foregoing disclosure includes the best mode for practicing the invention. It is apparent, however, that those skilled in the relevant art will recognize variations of the invention that are not explicitly described herein.

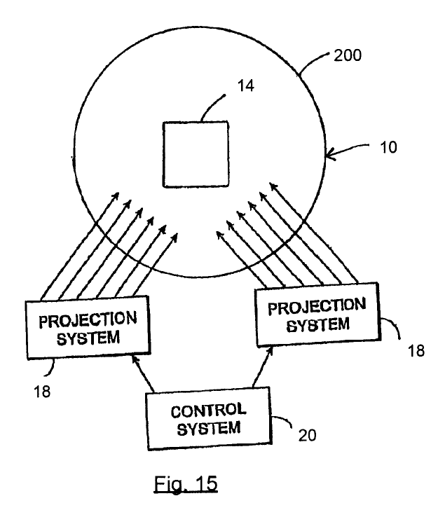

For example, referring to FIG. 14, shown therein is a marking system 100 that is constructed utilizing concepts of the invention discussed above but forms a permanent image 102 (which can be a two-dimensional or three-dimensional image), rather than an illuminated three dimensional image formed of energized particles as discussed above. In particular, the marking system 100 is provided with a substrate 104 in which the permanent image 102 is formed, a projection system 16a, a projection system 18a, and a control system 20a. The marking system 100 also is desirably provided with a device (not shown) for securely mounting and/or holding the substrate 104 in a predetermined registration relative to the projections system 16a and 18a while the permanent image 102 is being formed.

The substrate 104 can be formed of any translucent or transparent (doped or undoped) (colored or colorless) material capable of being permanently modified to form the permanent image 102. For example, the substrate 104 can be constructed of glass (such as tempered or laminated glass, acrylic glass, or ceramic glass), sapphire, diamond, plastic (such as polycarbonate), quartz or the like. The substrate 104 can be used for a variety of applications such as architectural or decorative applications (columns, windows, trophies, figurines or the like), security, tracing or informational marking applications (slides, eye glasses, products or the like), or advertising applications (signs, business cards or the like).

The projection systems 16a and 18a are similar to the projection systems 16 and 18 discussed above, with the exception that the projection systems 16a and 18a emit electromagnetic energy with sufficient power so as to cause a permanent visual modification to material within or forming the substrate 104. The term “permanent visual modification” as used herein refers to a change in the structure of the material, such as breaking, melting or cracking of the material which changes its visual properties. For example, the permanent visual modification can be a change in the opacity of the material.

It should be understood that the term “visual” as used herein refers not only to modifications perceivable directly by the human eye, but also refers to modifications that can be perceived by a machine or by a human eye with the aid of a machine, and/or with a certain incidence of light or defined illumination.

The control system 20a is similar to the control system 20 described above and in general is programmed with logic or instructions to output signals to the projection system 16a to energize material within the substrate 104 sequentially along the length and width of the substrate 104 (referred to above as a “slice” or a “two-dimensional image”) through projection of electromagnetic energy of one or more wavelengths; and the projection system 16b to project electromagnetic energy of one or more wavelengths along the depth of the volumetric display to intersect the energized material along the depth of the volumetric display to cause a permanent visual modification to the energized material forming the two-dimensional image. The control system 20a can also be programmed with logic or instructions to form a three-dimensional image. This is accomplished by controlling the projection systems 16a and 16b to create multiple permanent two-dimensional images along the depth of the substrate 104 in the manner discussed above such that the multiple permanent two-dimensional images act together to form the desired three-dimensional image within the substrate 104.

The image 102 can be a code, such as a bar-code or a data-matrix code, a scanned image (two-dimensional or three-dimensional) of a person, animal or object, one or more characters or symbols, or the like.

Referring now to FIG. 15, shown therein is an optional magnifier device 200 for use with the light surface display system 10 for receiving the illuminated three dimensional image generated within the volumetric display 14, magnifying the illuminated three dimensional image and outputting a magnified illuminated three dimensional image having an appearance larger than the illuminated three dimensional image. The magnifier device 200 generally will be constructed of a system of lenses and/or mirrors configured for changing the size or appearance of the illuminated three-dimensional image. In one embodiment, the configuration and/or placement of the lenses and/or mirrors can be fixed to form a passive device having a predetermined magnification. Alternatively, the magnifier device 200 can be an active device where the lenses and/or mirrors are movable with respect to each other so that the magnification can be varied.

As shown in FIG. 15, the magnifier device 200 surrounds at least a portion of the volumetric display 14 and preferably surrounds all sides of the volumetric display 14 so that the magnified illuminated three dimensional image is visible from a variety of perspectives.

While the invention is defined by the appended claims, the invention is not limited to the literal meaning of the claims, but also includes these variations.

What is claimed:

1. A method of producing multiple three-dimensional images to create an optical illusion of movement, comprising the steps of:
a. energizing particles suspended within a volumetric display sequentially along the length and width of the volumetric display through projection of electromagnetic energy of one or more wavelengths, the energized particles forming a two-dimensional image;
b. intersecting the energized particles through projection of electromagnetic energy of one or more wavelengths along the depth of the volumetric display;
c. synchronizing the projection of electromagnetic energy along the length and width of the volumetric display with the projection of electromagnetic energy along the depth of the volumetric display for a pre-determined length of time forming an illuminated three-dimensional image; and
d. repeating steps a, b and c for each of the plurality of three-dimensional images using a predetermined scanning sequence to create the optical illusion of movement.

2. The method of claim 1, wherein the volumetric display remains static while forming the illuminated three-dimensional image.

3. The method of claim 1, wherein projection of electromagnetic energy of one or more wavelengths is performed by a first projection system including a single digital light processor.

4. The method of claim 3, wherein power of the first projection system is modulated to provide variable brightness of the image.

5. The method of claim 3, wherein the projection of electromagnetic energy of one or more wavelengths along the depth of the volumetric display is performed by a second projection system including a single digital light processor having a digital micromirror device with an array of micromechanical mirrors.

6. The method of claim 5, further comprising the step of dithering the micromechanical mirrors to provide variable brightness of the image

7. The method of claim 1, further comprising the step of providing a pre-determined time-delay before intersecting the energized particles through projection of electromagnetic energy of one or more wavelengths along the depth of the volumetric display.

8. The method of claim 1, wherein the particles are supported by an aerogel matrix.

9. The method of claim 1, wherein the particles are substantially uniformly suspended.

10. The method of claims 1-9, wherein the scanning sequence is selected from the group consisting of back and forth scanning or interlaced scanning.

11. The method of claims 1-9, wherein the optical illusion of movement is selected from the group consisting of full rotating screen, half rotating screen, two Archimedes spirals rotating around a common center, and single spiral rotating screen.

12. A method of producing a permanent image within a substrate, comprising the steps of:
a. energizing material within the substrate sequentially along the length and width of the substrate through projection of electromagnetic energy of one or more wavelengths, the energized material forming a two-dimensional image;
b. intersecting the energized material through projection of electromagnetic energy of one or more wavelengths along the depth of the volumetric display to cause a permanent visual modification to the energized material forming the two-dimensional image.

13. The method of claim 12, wherein the permanent image is a three-dimensional image, and wherein steps a and b are repeated for multiple two-dimensional images along the length and width of the substrate with the projection of electromagnetic energy along the depth of the substrate to produce a permanent three-dimensional image within the substrate.

14. A light surface display for providing a three-dimensional image, comprising:
a plurality of particles suspended within a volumetric display;
a first projection system projecting sequential slices of electromagnetic energy of one or more wavelengths along the length and width of the volumetric display energizing particles to form a two-dimensional image;
a second projection system projecting translational slices of electromagnetic energy of one or more wavelengths intersecting with the energized particles across the depth of the volumetric display;
a control system synchronizing the projection of the image source and the activation source such that the two-dimensional image and the translational slices energize the particles for a pre-determined length of time so that the particles illuminate to form an illuminated three dimensional image; and
a magnifier device receiving the illuminated three dimensional image, magnifying the illuminated three dimensional image and outputting a magnified illuminated three dimensional image having an appearance larger than the illuminated three dimensional image.

15. The display of claim 14, further comprising a medium substantially transparent and dispersed within the volumetric display wherein the particles are suspended within the medium.

16. The display of claim 15, wherein the medium is selected from a group consisting of a transparent ceramic material, an aerogel matrix composed of an inorganic substance, an aerogel matrix composed of an organic substance, an xerogel matrix composed of an inorganic substance, an xerogel matrix composed of an organic substance, and a transparent glass ceramic matrix.

17. The display of claim 14, wherein the particles are selected from a group consisting of quantum dots, and an upconversion material.

18. The display of claim 14, wherein the first projection system includes at least one digital light processing projector.

19. The display of claim 14, wherein the first projection system projects wavelengths for a pre-determined amount of time prior to the second projection system projecting wavelengths intersecting the energized particles.

20. The display of claim 14, wherein the magnifier device surrounds the volumetric display.

21. The display of claim 14, wherein the magnifier device is positioned adjacent to the volumetric display and extends about at least a portion of the volumetric display.
